(19) United States
(12) Patent Application Publication
(10) Pub. No.: US 2023/0281679 A1
(43) Pub. Date: Sep. 7, 2023

(54) CONSUMER RATING SYSTEM

(71) Applicant: DIFFERENT LIKE YOU, INC., Washington, DC (US)

(72) Inventor: RHONDA JOHNSON, Washington, DC (US)

(21) Appl. No.: 18/116,126

(22) Filed: Mar. 1, 2023

Related U.S. Application Data
(60) Provisional application No. 63/315,824, filed on Mar. 2, 2022.

(51) Int. Cl. G06Q 30/0282; G06Q 30/0204

(52) U.S. Cl. CPC G06Q 30/0282; G06Q 30/0204

(57) ABSTRACT

The consumer rating system provides a custom match score to users for businesses and individual reviews for those businesses that takes the user's background into account. The consumer rating system also provides ally scores to the user which take into account preselected ally criteria selected by the user. The user is also able to provide responses to inclusion questions when leaving reviews that are taken into account when generating the match scores and ally scores for other users.

### CROSS-REFERENCE TO RELATED APPLICATIONS

This application claims priority to U.S. Provisional Application Ser. No. 63/315,824, filed Mar. 2, 2022, the entire contents of which are hereby incorporated by reference in their entirety.

### FIELD OF THE INVENTION

The present invention discloses a consumer rating system that helps the consumer identify businesses and services that are most welcoming to them based on measurements of inclusiveness.

### BACKGROUND

Current consumer rating systems allow users to rate businesses and leave a review. The review scores are aggregated to produce an overall rating score for the business while allowing users to see the individual reviews. However, these rating systems do not take into account the different experience that users from different demographics may have at the same business. Certain demographics may have a more positive, different, or negative experience at certain businesses, but these differences are not reflected in the overall rating score.

Further, when viewing reviews, users can generally only sort by date or review score. It is unclear to the user if the person leaving the review has similar or different demographics. Therefore, a need clearly exists for a rating system that takes into account user demographics and the similarities and differences between users of different demographics.

### SUMMARY

Disclosed herein is a consumer rating system for businesses that provides a custom match score to users that takes the user's background into account. The consumer rating system also provides ally scores to the user which take into account preselected ally criteria selected by the user. The user is also able to provide responses to inclusion questions when leaving reviews that are taken into account when generating the match scores and ally scores for other users.

### BRIEF DESCRIPTION OF THE DRAWINGS

FIG. 1 depicts a network diagram employed in a preferred embodiment of the consumer rating system of the present invention.

FIGS. 2-4 depict example screens utilized for onboarding new users.

FIG. 5 depicts an example search results screen for users.

FIG. 6 depicts an example review screen.

FIG. 7 depicts an example review creation screen.

FIG. 8 depicts an example administrative portal.

FIG. 9 depicts an example screen for reviewing flagging content.

### DETAILED DESCRIPTION

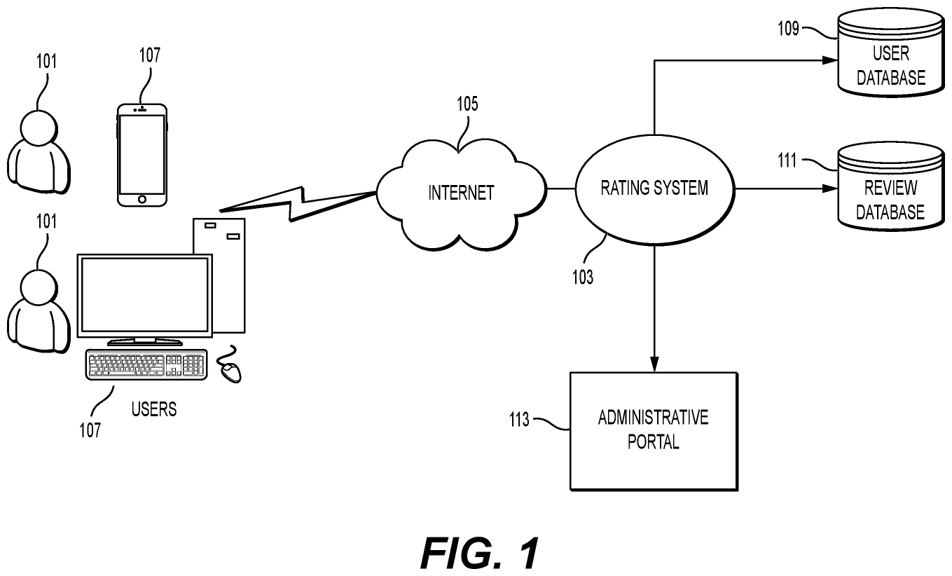

FIG. 1 depicts a network diagram employed in a preferred embodiment of the consumer rating system of the present invention. A plurality of users 101 are in communication with rating system 103 over internet 105 using their preferred devices 107 (e.g., smartphone, computer, tablet, etc.). Rating system 103 may be housed on a plurality of servers, on a web service, virtual computer, etc. The requirements for rating system 103 generally depend upon the number of users 101 utilizing the rating system 103.

Each user 101 is able to create an account at rating system 103 and their information, such as demographic information, is stored in user database 109. The users 101 may utilize rating system 103 to view scores assigned to various businesses at the reviews from other users. The scores and reviews are preferably stored in review database 111 in association with the reviewed business.

An administrative portal 113 is provided to allow a business owner or administrator to respond to reviews and/or flag reviews to be removed because they include inappropriate language or inaccuracies.

### User Onboarding

In a preferred embodiment, each user 101 must create an account with rating system 103 and answer a plurality of demographics questions during the onboarding process. Users 101 without accounts may view the ratings or reviews for businesses but cannot leave reviews themselves without accounts. During the onboarding process, the user is asked a plurality of questions regarding their demographics. This allows the rating system 103 to learn more about user demographics and provide recommendations based on the supplied demographics. This makes it easier for users 101 to discover welcoming businesses.

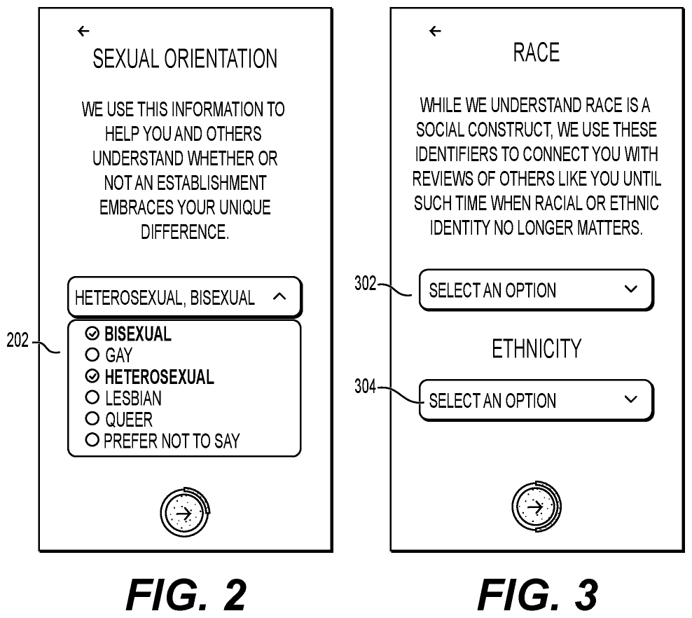

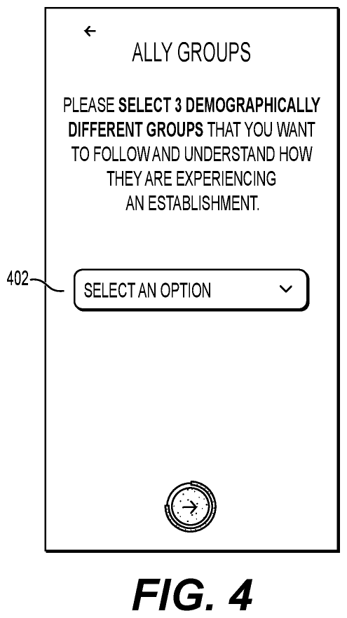

First, the user 101 is asked to select their gender identity such as man, woman, transgender (male or female), and non-binary. Next, as depicted in FIG. 2, the user 101 is asked to supply their sexual orientation. In a preferred embodiment, users can select up to two options 202 from six (or more) selection choices including bisexual, gay, heterosexual, lesbian, queer, or prefer not to say.

The user 101 is subsequently asked to supply demographic information concerning race 302 and ethnicity 304 as depicted in FIG. 3. Selections for race may include Alaskan Native, Asian, Black, Indian, Indigenous American, Middle Eastern, North African, Pacific Islander, White, or two or more. The selections from race 302 for review system 103 may be tailored based upon which country or region that review system 103 is meant to cover. For example, the selections for race 302 offered in a South American country may differ from those offered in an Asian country.

Similarly, the user 101 is also asked to supply their ethnicity 304 such as Hispanic/Latino or non-Hispanic/Latino. Like the selections for race 302, the selections for ethnicity 304 may also be varied based on region or country.

As the last step in the onboarding process, the user 101 is asked to select one or more demographically different “ally groups” 402 that the user 101 wants to follow to understand how they are experiencing an establishment. Ally groups 402 may comprise, but are not limited to Alaskan Native, Asian, Black, Hispanic/Latino, Indian, Indigenous American, LBTQ, Men, Middle Eastern, Non-Binary, North African, Pacific Islander, Persons with disabilities, two or more, White, and Women. Other groups may include dietary restrictions such as vegan, vegetarian, GF (gluten free), etc.

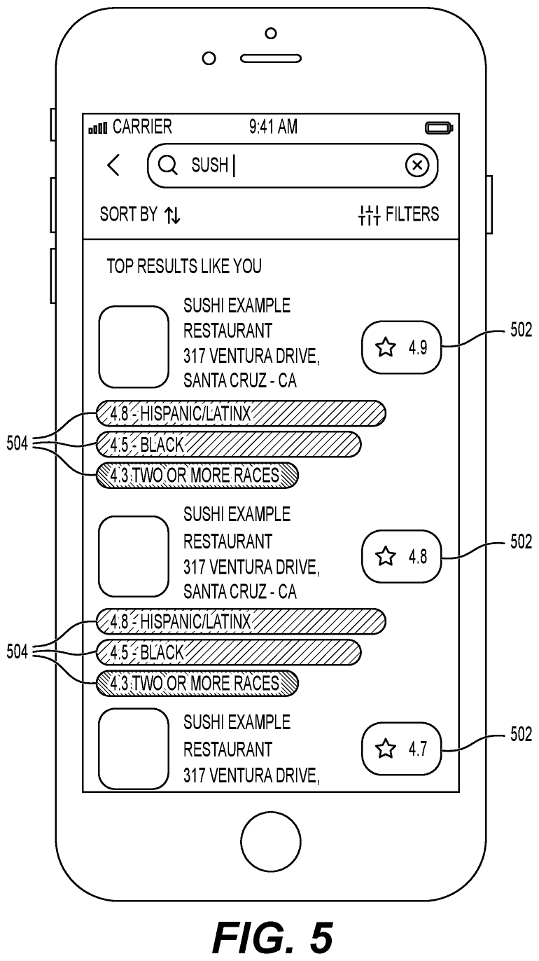

Once all user information has been supplied during the onboarding process, the demographic information is stored in association with the user's account in user database 109. At this point, the user 101 is free to search reviews in review database 111. An example results screen for a search is depicted in FIG. 5. As shown, the user is provided with their own unique score 502 (shown enlarged). The ally scores 504 generated for the ally selection are also displayed adjacent the business name. This allows the user 101 to see a score 502 that is specifically calculated for them based on their selected demographic while also retaining the ability for the user to see ally scores 504 calculated for various ally groups.

### Review Searching and Navigation

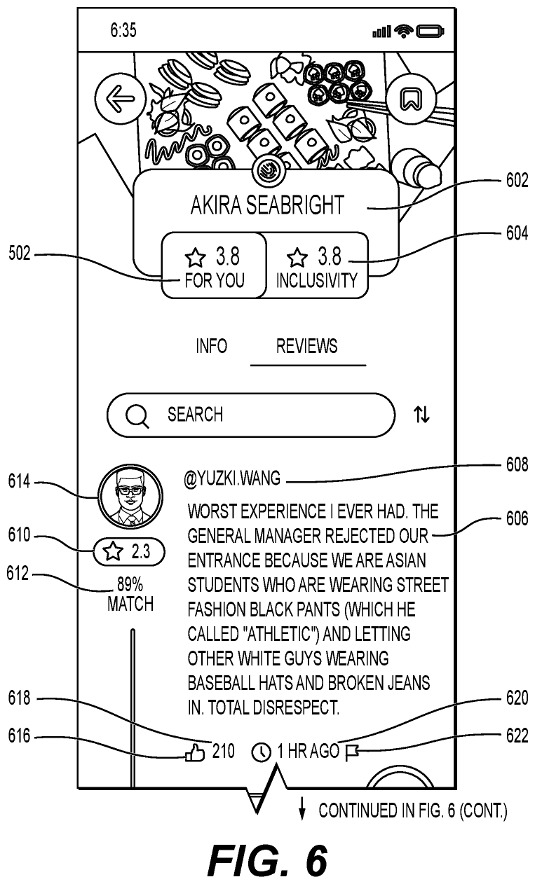

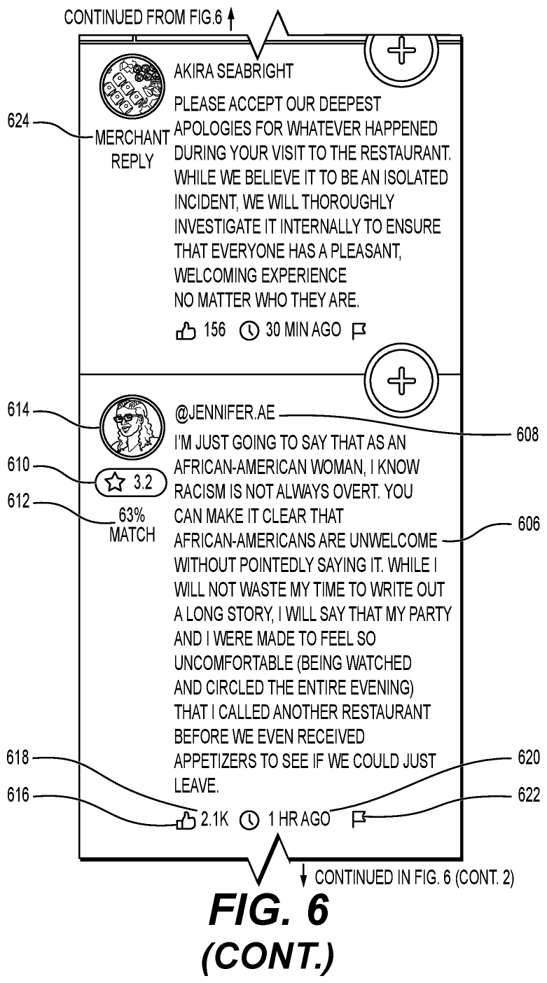

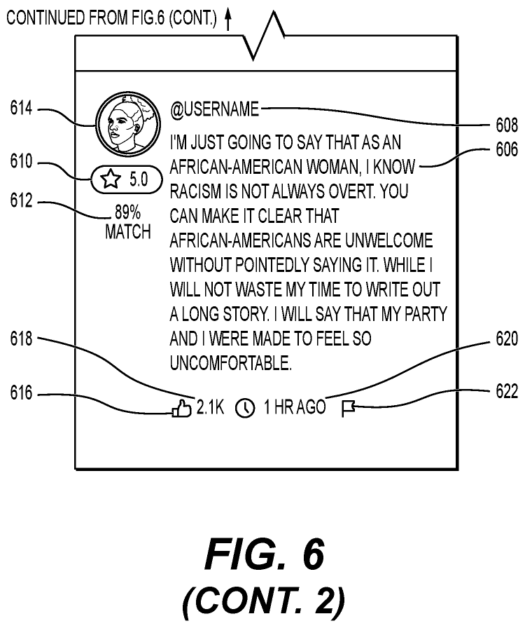

From this screen, the user 101 can select a business to view further information about the business such as reviews from individual users. Users 101 can also search reviews based on specific keywords. An example of a screen showing a plurality of reviews provided to user 101 is depicted in FIG. 6. Preferably, the business name 602 is shown in close proximity to the score 502 calculated for user 101 and an overall inclusivity score 604. Other identifying information such as business type, neighborhood, address, category, etc. may also be displayed. Reviews are provided and can be sorted by a plurality of criteria (match score, review date, review score, etc.). For each review displayed, the user 101 is provided with the text of the review 606, the username 608 of the person posting the review, the rating 610 selected by the reviewer, and a match score 612. The match score 612 may be displayed as a percentage or as a level (e.g., very good match, good match, bad match, etc.). Each review displayed also preferably includes, a user avatar 614, a like button 616 and amount 618, a time stamp 620, and a flag content button 622.

The match score 612 is calculated by comparing the demographic information supplied by the viewing user 101 to that of the user that made the review. When calculating the match score 612 between the two users, each demographic is supplied a different weight. The weighted demographics are then summed to determine the match score 602. Example weights for demographics may include:

Race: 14%

Ethnicity: 12%

Gender 10%

Sexual Orientation: 12%

Disability: 10%

Appearance: 10%

Language Proficiency 10%

Income Range: 10%

Age: 12%

Alternatively, the user 101 may be provided with a rating of the match percentage such as perfect match (68-100), great match (48-68), or good match (under 48). Additional qualifications may be imposed on the matches such as requiring that race, gender, or ethnicity match in a perfect match or that race or ethnicity match in a great match, Each review may also comprise a merchant reply 624 allowing the business to respond to the review.

### Review Creation

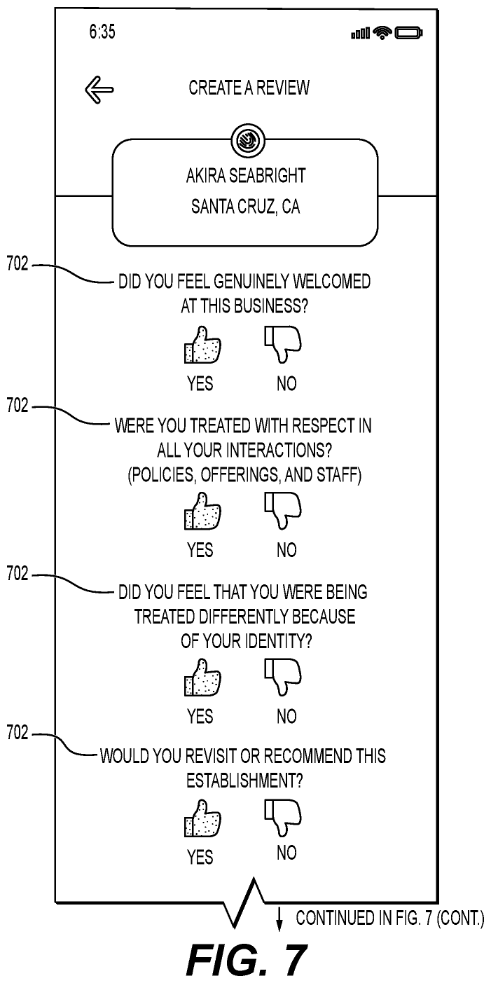

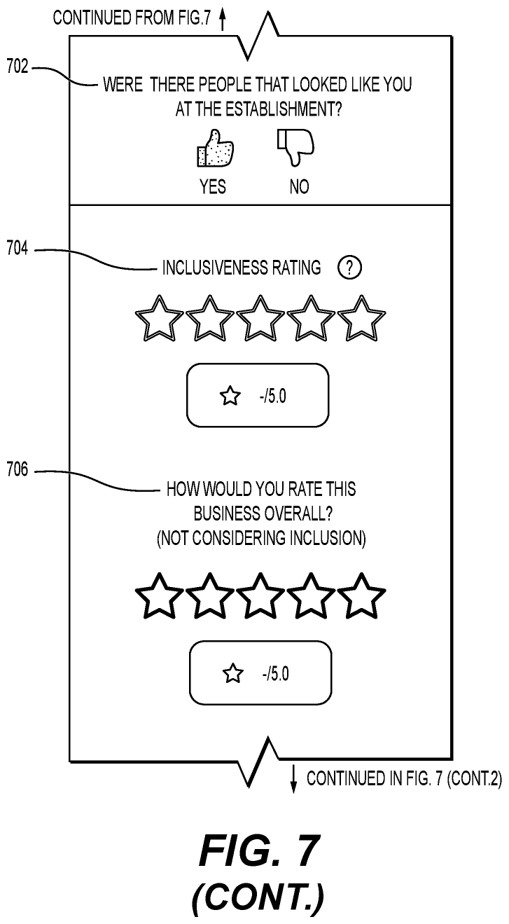

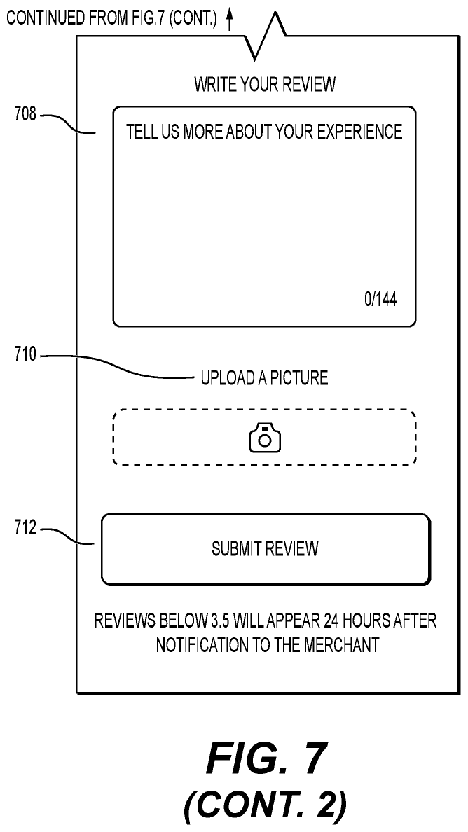

Users 101 can also use rating system 101 to leave reviews for other users. When leaving a review, the user 101 is asked to answer a series of inclusion questions in addition to other information (food quality, service, location, etc.). An example review creation screen is depicted in FIG. 7. Users answer 101 Yes or No to six (or more) questions about their experience and whether it was welcoming and inclusive. The questions 702 are inclusion indicators validated through research. Each question 702 answered by a reviewer is assigned a point value and those values are combined to determine a merchant score for inclusiveness. The inclusion questions 702 preferably include the following:
Did you feel genuinely welcomed at this business?
Were you treated with respect in all of your interactions?
Did you feel that you were being treated differently because of your identity?
Would you revisit or recommend this establishment?
Were there people that looked like you at the establishment?
Inclusiveness rating?

Each inclusion question 702 is given a numerical value and those are combined with the rating scale to achieve a score. All reviewer scores are combined to determine a merchant's inclusion rating. The inclusion scores can further be broken out based on identify factors such as race, gender, ethnicity, etc.

Reviewers can also provide ratings (e.g., out of 5) for different aspects of the business. For examples, reviewers may provide an inclusiveness rating 704 and an overall rating 706. Reviewers may also optionally leave comments 708 and upload photos 710. One the reviewer is satisfied with the review, the reviewer can click the submit review button 712 to submit the review. In some embodiments, reviews with a score below a predetermined threshold (e.g., below 3.5) may be delayed for a time period (e.g., 24 hours) to give the business owner time to respond or address points made in the review.

### Administrative Portal

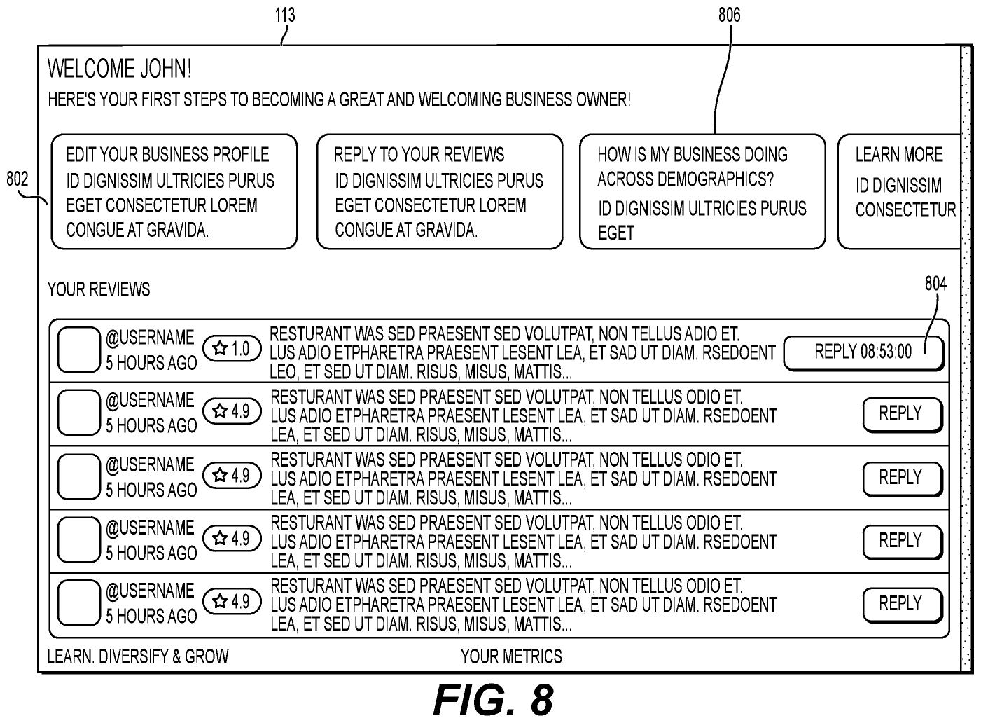

Administrative portal 113 allows a business owner or administrator to manage their listing at rating system 103. For example, tools 802 may be provided to allow a description to be added or edited. An example home screen for administrative portal 113 is depicted in FIG. 8. Reviews can be replied to using administrative portal 113. Preferably, a time limit 804 is set in which a reply can be posted as depicted. The time limit 804 allows merchants to respond to poor reviews within 24 hours (or other time period) before they post, providing time for a merchant to manage potential reputational damage.

Different levels of administrator levels may be set. For example, the adding or deleting of reviews may be restricted to a site administrator instead of a business administrator, otherwise business could delete reviews that they don't agree with which would reduce trust in the review system.

The administrator can select the analysis tab 806 to see how their business is doing across demographics. Here, the administrator can view analytics for their business, such as levels of inclusivity for different demographics. This allows them to determine how well they are doing within a specific demographic consumer group. Further, the inclusiveness scores are intersected to achieve other data sets that determine how well a merchant is servicing consumers based on several identity factors (i.e. black and gay, female and hispanic, white and disabled, etc.).

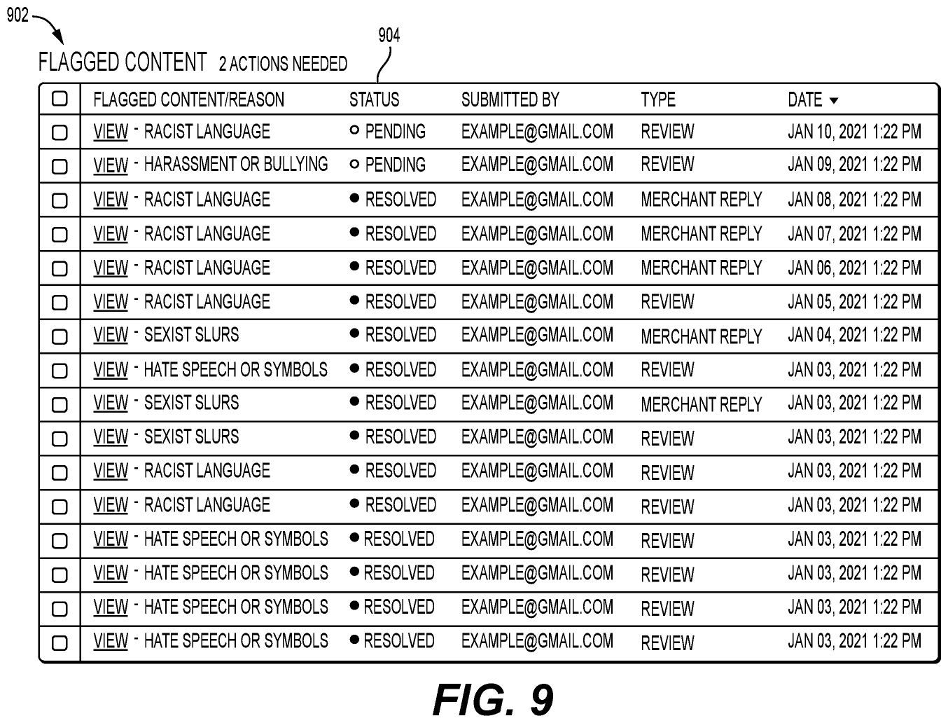

Administrative portal 113 can further be utilized to respond to reviews or other information that has been flagged. The flagging may be automated (e.g., detection of harassment, bullying, racist language, etc.) or in response to users 101 flagging reviews. An example flagged content screen 902 is depicted in FIG. 9. As already mentioned, the site can view this page and take action with respect to specific reviews. For example, the administrator may delete a post that includes offensive language. After the flag has been handled, the status 904 is changed from pending to resolved.

1. A method of generating custom reviews for a user comprising:
receiving, from a reviewer, a plurality of demographic information a plurality of responses to inclusion questions, and a review;
comparing the plurality of demographic information from the reviewer to a same plurality of demographic information from the user;
weighting each of the demographic information with a demographic weight, wherein a sum of the demographic weights is one;
summing the weighted demographic information to calculate a match score between the reviewer and the user; and
displaying the match score to the user adjacent to the review from the user.

2. The method according to claim 1, wherein the plurality of demographic information from the user comprises race, ethnicity, gender, sexual orientation, disability, appearance, language proficiency, income range, and age.

3. The method according to claim 2, wherein the race weight is 0.14, the ethnicity rate is 0.12, the gender weight is 0.1, the sexual orientation weight is 0.12, the disability weight is 0.1, the appearance weight is 0.1, the language proficiency weight is 0.1, the income weight is 0.1, and the age weight is 0.12.

4. The method according to claim 1, wherein the review further comprises a number of likes and a review date. review.

5. The method according to claim 1,
wherein a plurality of other reviews are displayed adjacent the review, and
wherein each other review includes a match score related to the user that composed the review.

6. The method according to claim 1, wherein the review includes a flag button to flag the review for review.

7. The method according to claim 1, wherein an owner of the business provides a response of the flagged review.

8. The method of claim 1, wherein an owner of the business is provided a predetermined time period to post a response to the review.

9. The method of claim 1, further comprising:
determining a custom rating for the business based on reviews from reviewers with similar demographics to the user;
determining an inclusivity rating for the business based on responses to inclusion questions received from a plurality of reviews for the business; and
displaying the custom rating and the inclusivity rating to the user adjacent a name of the business.
